(19) United States
(12) Patent Application Publication
(10) Pub. No.: US 2023/0270528 A1
(43) Pub. Date: Aug. 31, 2023

(54) SYSTEM AND METHOD OF PRODUCING DENTAL APPLIANCES USING ADDITIVE MANUFACTURING

(71) Applicant: SprintRay Inc., Los Angeles, CA (US)

(72) Inventors: Amir Mansouri, Los Angeles, CA (US); Vitalik Dubytskyi, Los Angeles, CA (US); Cary Forest, Los Angeles, CA (US); Ehsan Barjasteh, Los Angeles, CA (US)

(21) Appl. No.: 18/114,537

(22) Filed: Feb. 27, 2023

Related U.S. Application Data
(60) Provisional application No. 63/314,906, filed on Feb. 28, 2022.

(51) Int. Cl. A61C 7/08; A61C 13/00

(52) U.S. Cl. CPC A61C 7/08; A61C 13/0019

(57) ABSTRACT

A system and method of producing dental appliances is provided. The system includes a 3D printer system and one or more additional additive manufacturing systems. The additional additive manufacturing systems are designed to add one or more layers of materials to dental appliances printed using the 3D printer system. By adding the layers of materials to the 3D printed appliance, the physical and mechanical properties of the 3D printed appliance are modified as required.

### FIELD OF THE INVENTION

This invention relates to dental appliances, including a system and method of producing dental appliances using additive manufacturing.

### BACKGROUND

Transparent dental appliances, such as retainers and aligners, are typically fabricated using thermoplastic polymers that offer desirable elastic properties. The elastic properties of the appliances are necessary for various types of dental treatment plans, e.g., to move the teeth (aligners) or to prevent teeth that were already moved from moving back (retainers).

However, the fabrication process of such thermoplastic appliances is generally inefficient, labor intensive, and costly. For example, a mold of the patient’s teeth much first be created, and then a thermoforming system is used to form the thermoplastic on top of the mold. Next, the excess plastic must be trimmed and cut along the gumline to create the appliance.

Stereolithography three-dimensional (3D) printing systems offer a much more efficient process of creating a wide variety of dental products, however, the resins available for this type of process are not well suited for fabricating retainers, aligners, and other types of appliances that require particular physical and mechanical properties, e.g., elasticity. For this reason, stereolithography 3D printing systems are not currently usable for fabricating these types of dental appliances.

Accordingly, there is a need for a system and method that first 3D prints a dental appliance, and that subsequently modifies the appliance’s physical and mechanical properties as required for successful application of the appliance.

### SUMMARY

According to one aspect, one or more embodiments are provided below for a system and method of producing dental appliances using additive manufacturing.

One aspect of the present invention involves a method of forming a dental appliance. In exemplary embodiments, the method may include: (A) receiving a design file representing the dental appliance; (B) printing, using a three-dimensional (3D) printer and the design file, the dental appliance, the dental appliance being fully cured and including at least one initial physical property value; (C) applying, using a first additive manufacturing system, a first layer of a first material to at least one first surface of the dental appliance to form a modified dental appliance; wherein the at least one initial physical property value of the dental appliance is changed to a corresponding at least one modified physical property value of the modified dental appliance by the application of the first layer of first material in (C).

In some exemplary embodiments, the dental appliance includes at least one of a retainer, and an aligner.

In some exemplary embodiments, the at least one initial physical property includes at least one of tensile strength, elasticity, elongation, impact resistance, rigidity, mechanical strength, hardness, wear resistance, color, and transparency.

In some exemplary embodiments, the first material includes at least one of thermoplastic, acrylic, and epoxy.

In some exemplary embodiments, the first additive manufacturing system includes at least one of a material dipping system, material spraying system, material coating system, material wrapping system, material heat shrinking system, material depositing system, and material painting system.

In some exemplary embodiments, the method may further include step (C)(1) curing the first layer of first material on the at least one first surface. In some exemplary embodiments, the method may further include step (C)(1) activating the adhesion between the first layer of first material and the at least one first surface.

In some exemplary embodiments, the activating the adhesion between the first layer of first material and the at least one first surface is provided by at least one of exposure to ultraviolet light, an addition of a curing and/or activation agent, exposure to heat, and the passing of time.

In some exemplary embodiments, the method may further include step (A)(1) modifying the design file by modifying at least one parameter of the represented dental appliance within the design file.

In some exemplary embodiments, the modifying the design file by modifying at least one parameter includes modifying at least one surface of the represented dental appliance within the design file. In some exemplary embodiments, wherein the modifying the design file by modifying at least one parameter includes modifying at least one thickness of the represented dental appliance within the design file.

In some exemplary embodiments, the method may further include (D) applying, using a second additive manufacturing system, a second layer of a second material to at least one second surface of the modified dental appliance to form an additionally modified dental appliance;

wherein the at least one modified physical property value of the modified dental appliance is changed to a corresponding at least one additionally modified physical property value of the additionally modified dental appliance by the application of the second layer of second material in (D).

In some exemplary embodiments, the second material includes at least one of thermoplastic, acrylic, and epoxy.

In some exemplary embodiments, the second additive manufacturing system includes at least one of a material dipping system, material spraying system, material coating system, material wrapping system, material heat shrinking system, material depositing system, and material painting system.

In some exemplary embodiments, the second additive manufacturing system is the same as the first additive manufacturing system.

In some exemplary embodiments, the method may further step (D)(1) curing the second layer of second material on the at least one second surface.

In some exemplary embodiments, the method may further step (D)(1) activating the adhesion between the second layer of second material and the at least one second surface.

In some exemplary embodiments, the activating the adhesion between the first layer of first material and the at least one first surface is provided by at least one of exposure to ultraviolet light, an addition of a curing and/or activation agent, exposure to heat, and the passing of time.

In some exemplary embodiments, the dental appliance includes a shell with a shell outer surface and a cavity with a cavity inner surface, and the first layer of the first material is applied to the shell outer surface and/or the cavity inner surface.

In some exemplary embodiments, the method may further step (C)(1) obstructing, using a blocking member, at least a portion of dental appliance from the application of the first layer of first material.

The presently disclosed system and method of producing dental appliances using additive manufacturing is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows a dental appliance production system in accordance with exemplary embodiments hereof;

FIG. 2 shows aspects of dental appliance in accordance with exemplary embodiments hereof;

FIG. 3 shows aspects of a 3D printed item in accordance with exemplary embodiments hereof;

FIG. 4 shows aspects of a 3D printed item with additional layers in accordance with exemplary embodiments hereof;

FIG. 5 shows workflow actions that may be taken in accordance with exemplary embodiments hereof;

FIG. 6 shows a dental appliance in accordance with exemplary embodiments hereof;

FIG. 7 shows aspects of a 3D printed item in accordance with exemplary embodiments hereof;

FIG. 8 shows aspects of a 3D printed item including a blocking member in accordance with exemplary embodiments hereof;

FIG. 9 shows aspects of a 3D printed item including a blocking member in accordance with exemplary embodiments hereof;

FIG. 10 shows impact strength test results in accordance with exemplary embodiments hereof; and

FIG. 11 shows a pigment change of a dental appliance in accordance with exemplary embodiments hereof;

### DETAILED DESCRIPTION OF EXEMPLARY EMBODIMENTS

In general, the system and method according to exemplary embodiments hereof includes a system and method of producing dental appliances using a three-dimensional (3D) printer and secondary additive manufacturing systems. The 3D printer is used to print an initial version of a dental appliance with resulting initial physical and mechanical properties. The secondary additional manufacturing system(s) are then used to modify the initial physical and mechanical properties of the 3D printed appliance to produce a new appliance with modified properties for successful implementation of the appliance as required.

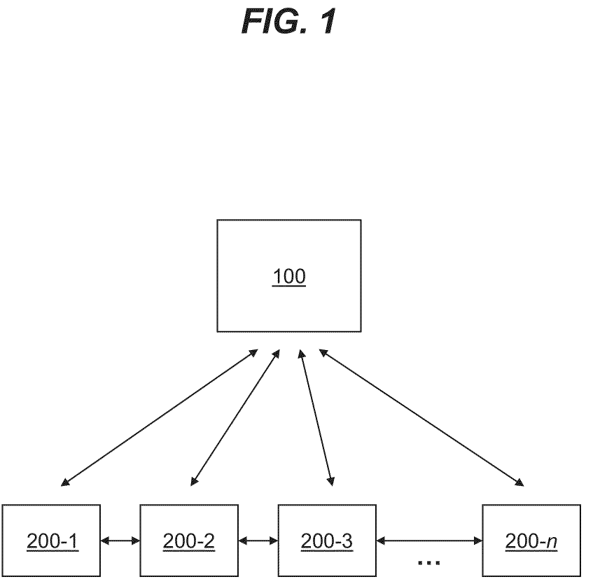

In one exemplary embodiment hereof, as shown in FIG. 1, the dental appliance production system 10 (also referred to herein as simply the system 10) includes a 3D printing system 100, and one or more additional additive manufacturing systems 200-1, 200-2, 200-3, ... 200-n (individually and collectively 200). The system 10 also may include additional elements as necessary for the system 10 to perform its functionalities.

In general, the system 10 first produces an item I (e.g., a dental appliance) using the 3D printing system 100. Once formed, the item’s I’s initial physical and mechanical properties, e.g., its initial tensile strength, elasticity, elongation, impact resistance, rigidity, mechanical strength, hardness, wear resistance, color, transparency, etc., will depend, at least in part, on the type(s) of resin(s) used during the 3D printing process. However, these initial physical and mechanical properties may not meet the specifications required by the final product (e.g., the final dental appliance). Accordingly, the initial 3D printed item may require physical modifications to adjust its properties and to ultimately reach its desired mechanical working specifications.

To accomplish this, the system 10 may implement one or more additional processes to the item I using one or more additional additive manufacturing systems 200. In some embodiments, the additional additive manufacturing systems 200 include systems capable of applying one or more layers of materials to an outer surface of an item I. Once the new layer(s) of material are applied, the resulting modified item I may exhibit physical and mechanical properties that include the influencing properties of the added layer.

For example, the system 10 may apply a first layer of a first additive material to a surface of the item I. This may incorporate the first additive material’s physical and mechanical properties to the item I resulting in a first modified item Iₘ₁ with modified physical and mechanical properties.

Once the first additive layer has been applied, the system 10 may apply a second layer of a second additive material to the same or different surface of the first modified item Iₘ₁, thereby incorporating the second additive material’s physical and mechanical properties to the item Iₘ₂ as well. This process may continue until a desired plurality of additional physical and mechanical properties are combined in aggregate to produce a final item I_{mF} of final properties.

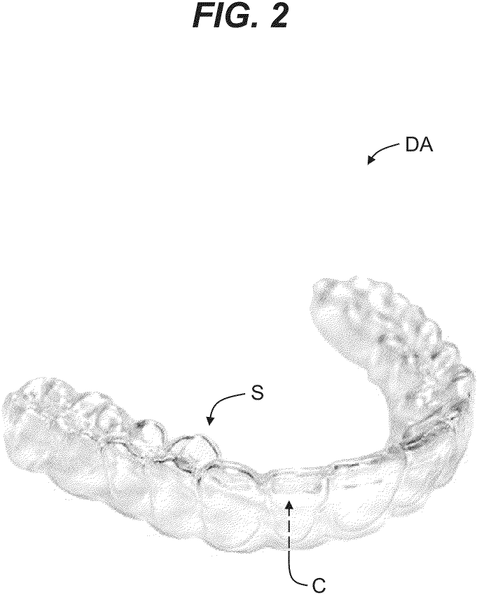

In some embodiments, as shown in FIG. 2, the system 10 is used to produce one or more types of dental appliances DA, such as, but not limited to, retainers, aligners, and other types of dental appliances. In some embodiments, the dental appliances DA include an outer shell S and an inner cavity C (e.g., from below) designed to receive the patient’s teeth.

The system 10 and method will next be described in detail with respect to FIGS. 1-9.

### 3D Printing System 100

In some embodiments, the 3D printing system 100 includes a three-dimensional (3D) printing system. For the purposes of this specification, the system 10 will be described primarily as a stereolithography (SLA) 3D printer 100 to produce the initial items I (e.g., the dental appliances). However, it is understood that any type of 3D printer may be used and that the scope of the system 10 is not limited in any way by the type of 3D printer system(s) that it may employ. For example, the system 10 also may employ multi-jet fusion (HJF), fused deposition modeling (FDM), digital light processing (DLP), selective laser sintering (SLS), selective laser melting (SLM), electron beam melting (EMB), laminated object manufacturing (LOM), binder jetting (BJ), material jetting/wax casting, other types of 3D printing systems, and any combinations thereof.

As mentioned above, the initial physical and mechanical properties of the initial 3D printed item I will depend, at least in part, on the type of photopolymer resin used to form the initial item I during the 3D printing process.

In some embodiments, the 3D printing resin is created from a mixture of aliphatic urethane oligomers, aromatic urethane oligomers, acrylic monomers, methacrylic monomers, oligomers, and/or other constituents. Examples include polyethylene glycol dimethacrylate (PEGDA), triethylene glycol dimethacrylate (TEGDMA), ethoxylated bisphenol A diacrylate, and cyclic trimethylolpropane acrylate. In addition, less than 3 wt.% of type I, type II photoinitiators, or blends thereof, may be added to a formulation. Examples of photoinitiators include 2, 4, 6-Trimethylbenzoyl-diphenyl phosphine oxide (TPO), Bis (2, 4, 6-Trimethylbenzoyl) phenylphosphine oxide (BAPO), camphorquinone (CQ), and 2-Isopropyl thioxanthone. It is understood that the above examples are meant for demonstration and that any other resin(s) of any other formulation(s) also may be used.

### Additional Additive Manufacturing Systems 200

In some embodiments, as shown in FIG. 1, the system 10 includes at least one additional additive manufacturing system 200-1, 200-2, 200-3, ... 200-n (individually and collectively 200). In some embodiments, the additional additive manufacturing systems 200 may include systems that may add one or more layers of material to one or more surface(s) of the initial 3D printed item I. As will be described herein, the added layers of material may modify the initial item’s physical and/or mechanical properties. In some embodiments, the added layers of material may include any types of thermoplastics, acrylics, epoxies, any other suitable materials, and any combinations thereof.

Types of additional additive manufacturing systems 200 may include material coating systems 200-1, material wrapping systems 200-2, material heat shrinking systems 200-3, material depositing systems 200-4, material spraying systems 200-5, material dipping systems 200-6, material painting systems 200-7, other types of systems 200-n that may add one or more layers of materials to the item, and any combinations thereof.

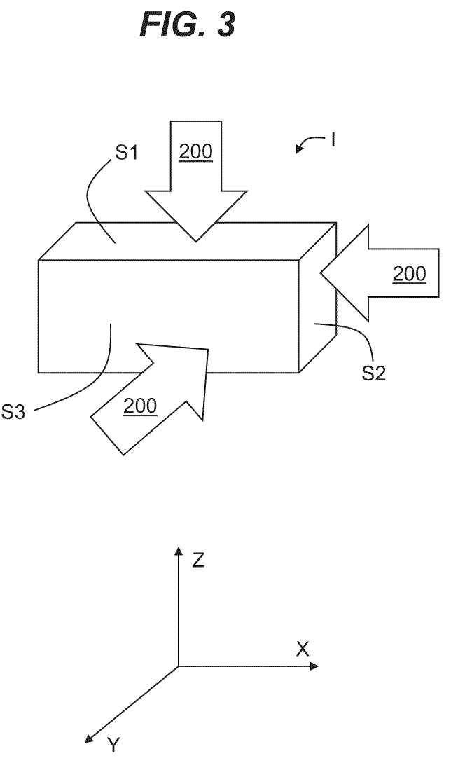

In some embodiments, as shown in FIG. 3, the additional additive manufacturing systems 200 may apply one or more new layers of material(s) to the initial item I along any single plane. For example, the additional additive manufacturing systems 200 may apply a new layer of material to the top surface S1 of the initial item I along the Z-plane.

In some embodiments, as shown in FIG. 3, the additional additive manufacturing systems 200 may apply one or more new layers of material to the initial item I along any combination(s) of two planes. For example, the additional additive manufacturing systems 200 may apply a new layer of material to the top surface S1 and to a side surface S2 of the initial item I along any combination(s) of the Z-plane and the X-plane.

In some embodiments, as shown in FIG. 3, the additional additive manufacturing systems 200 may apply one or more new layers of material to the initial item I along any combination(s) of three planes. For example, the additional additive manufacturing systems 200 may apply a new layer of material to the top surface S1, to a first side surface S2, and to a second side surface S3 of the initial item I along any combination(s) of the Z-plane, the X-plane, and the Y-plane.

The initial 3D printed item I is represented in FIG. 3 as a cuboid with surfaces S1, S2, S3 represented as rectangular planes for demonstration and for easy understanding, however, it is understood that the item I may include any form and/or any combination(s) of forms and that the surfaces S1, S2, S3 may follow any types of contours, shapes, or forms as dictated by the 3D printed item I (e.g., the various contours on a dental appliance).

It also is understood that the additional additive manufacturing systems 200 may apply new layers of materials to some surfaces and not to others. For example, the systems 200 may apply some new layers of some materials to some surfaces of the item and other new layers of other materials to other surfaces of the item, and/or any combinations thereof. In addition, some surfaces may not receive additional layers of material at all.

Given the above, it is understood that the additional additive manufacturing systems 200 may apply one or more new layers of material to any surface(s) along any combination(s) of planes of the item I as required, and that the scope of the system 10 is not limited in any way by the surfaces or number of planes upon which it may add new layers of material to the item I. Other types of additional additive manufacturing systems 200 also are contemplated as described herein or otherwise.

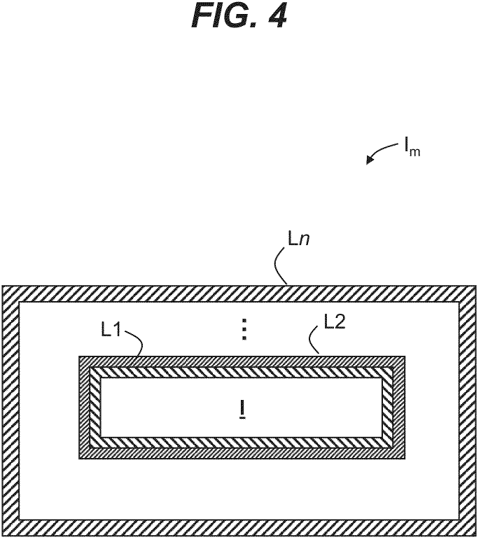

Expanding on the example shown in FIG. 3, FIG. 4 shows a cross-sectional view of an item I (again as a rectangle for easy understanding) with added layers L1, L2, L3, ... Ln. In this example, each layer L1, L2, ... Ln has been added to the item I sequentially and along all of the Z-, X-, and Y-planes. Note that the materials used to provide each new layer L1, L2, ... Ln may be the same or different from one another. For example, the first layer L1 may comprise a first material, the second layer L2 may comprise a second material, and the n^{th} layer Ln may comprise the first material, the second material, a third material, and/or an n^{th} material. Also, the thicknesses of each layer L1, L2, ... Ln may be the same or different depending on the application.

In some embodiments, the types of added materials are chosen depending on the physical and mechanical properties that are desired to be added to the item I. For example, in the case of fabricating a dental appliance, a layer of thermoplastic may be added to the 3D printed appliance to enhance the appliance’s elasticity (due to the desirable elastic properties of thermoplastic). Subsequently, a layer of a rigid material may be added on top of the layer of thermoplastic to provide additional rigidity to the item I in the area of the applied rigid layer. It is understood that any number of layers of any material(s) may be added to the item I to provide any number of added physical attributes in any areas of the item I.

In some embodiments, the thickness of each added layer also may depend upon the properties of the added layer and how much of the added material is required to provide the desired modified properties. In exemplary embodiments, the layer of thermoplastic is of a thickness suitable to provide the desired elasticity improvement to the original 3D printed dental appliance.

In some embodiments, the additional layers of material are simply added to every surface of the item I, (e.g., the dental appliance may be dipped in the new material), while in other embodiments, the additional layers are added to particular surfaces and/or areas of the item I depending on various criteria. For example, in some embodiments, the surface upon which the new layer of material is added may depend on the ultimate use of the item I. For instance, in the case of a dental appliance, the upper portion of the appliance may be subjected to significant downward forces when worn (e.g., due to biting). Accordingly, the upper surface of the 3D printed appliance may be chosen to receive an additional layer of material of high impact strength to reinforce the appliance in this area.

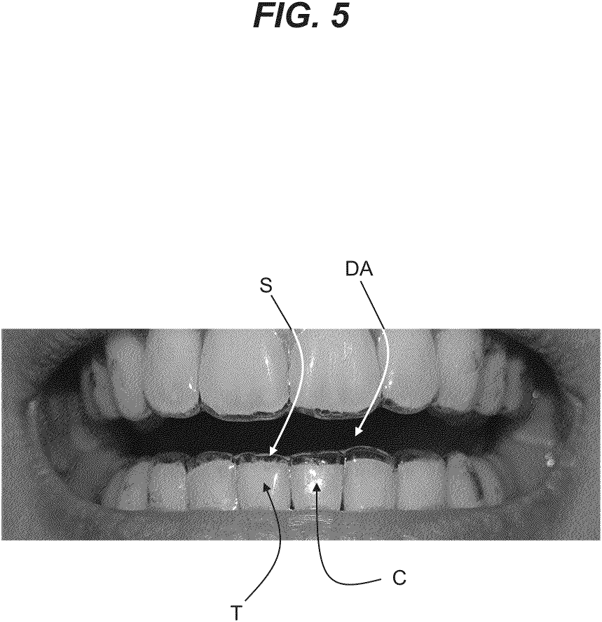

FIG. 5 shows a dental appliance DA placed on a lower row of a patient’s teeth T. As shown, the dental appliance DA includes an outer shell S with a lower cavity C into which the patient’s teeth T are received and held by the appliance DA. In this way, the dental appliance DA is able to affect the placement and positions of the teeth T as required by the dental procedure. The cavity C is formed using a mold or digital scan of the patient’s teeth T and is designed to coincide with the form and shape of the teeth T for proper fit. As is known, proper fit is essential to facilitate a successful dental treatment plan.

Given the above, it can be seen that additional layers of material applied to a surface within the cavity C may change the geometries and dimensions of the surfaces within the cavity C thereby potentially negatively affecting the appliance’s fit.

Accordingly, in some embodiments, it may be preferable to adjust the computer aided design (CAD) file of the initial dental appliance DA to account for the expected changes in the cavity’s dimensions, geometries, and forms due to the addition of the new layers of material. For example, it may be preferable to slightly increase the internal size of the cavity C by the amount of thickness expected to be added by the new material layers such that after the layers are applied the cavity’s size fits the patient’s teeth as required. In some embodiments, this may include reducing the wall thickness of the dental appliance in the cavity areas that may be affected. In other embodiments, this may include increasing the overall size of the dental appliance (the cavity C) so that the added new layers bring the overall size of the cavity C back to the desired dimensions and forms. Once the CAD file has been modified, the modified CAD file may be used to 3D print the initial dental appliance DA.

In other embodiments, any portion of the dental appliance DA, e.g., the cavity C, may be blocked, obstructed, or otherwise restricted from receiving additional layers of materials in order to preserve the proper fit of the appliance.

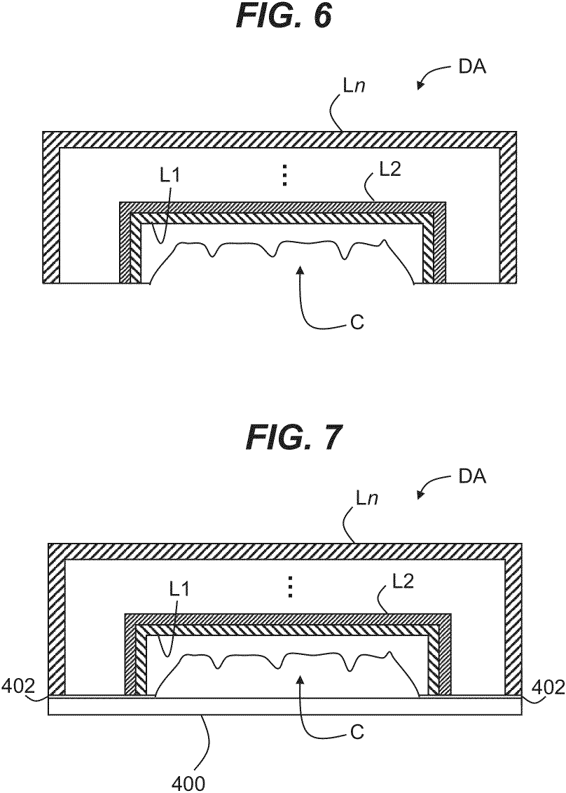

FIG. 6 shows a cross-sectional view of an item I (again as a rectangle for easy understanding) with new material layers L1, L2, ... Ln added to the top and sides of the item I by the additional additive manufacturing systems 200, but not to the bottom of the item I. In addition, FIG. 6 shows a generalized representation of a lower cavity C that represents the lower cavity C of the dental appliance DA in FIG. 5.

In some embodiments, as shown in FIG. 7, the system 10 provides a blocking member 400 applied to a surface of the 3D printed dental appliance that is not to receive additional layers of material. By physically blocking the surface, the blocking member 400 ensures that no additional layers of materials are applied to the surface. In the case of the example shown in FIG. 7 (e.g., a dental appliance DA), the blocking member 400 blocks the lower cavity C and ensures that no additional layers of material are applied to any surface within the cavity C.

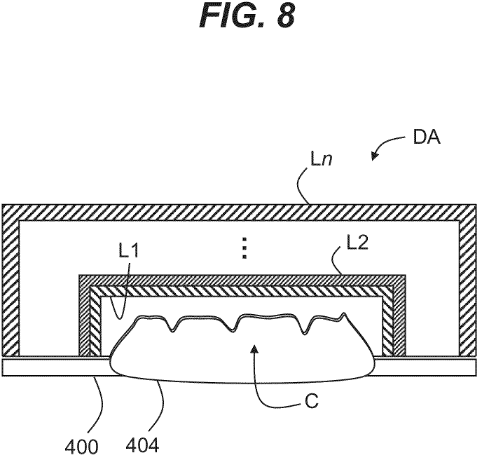

In some embodiments, as shown in FIG. 8, the blocking member 400 may include an insert portion 404 that is received into the cavity C and that generally matches the inner contours of the cavity C (i.e., the insert portion 404 matches the form and curvatures of the patient’s teeth). In this way, the blocking member 400 may further ensure that no added layers of material are applied to any surface within the cavity C.

In some embodiments, the blocking member 400 is 3D printed in combination with the dental appliance DA. In this case, it may be preferable that the interface between the blocking member 400 and the dental appliance DA is formed by thin layers of cured 3D printed material so that the blocking member 400 may be easily removed (e.g., cut or pulled off) after the additional layers of materials are added to the appliance DA and the appliance DA is ready for use. For example, as shown in FIG. 7, the blocking member 400 may include small securing tabs 402 that may hold the blocking member 400 in place and that may be cut or broken by hand to remove the blocking member 400. The securing tabs 402 may be located at the periphery of the blocking member 400 and/or in any other suitable location(s). In some embodiments, after the blocking member 400 is removed, the dental appliance DA may be cleaned to remove any excess 3D printed material (e.g., remnants of the securing tabs 402) as required.

In other embodiments, the blocking member 400 may be added to the 3D printed dental appliance DA after the appliance DA is 3D printed. In this case, the blocking member 400 may include a jig or other type of member that may be temporarily attached to the dental appliance DA during the addition of the added layers, and then removed. For example, the blocking member 400 may include thin attachment tabs, detents, notches, and/or other types of members that may grip and/or hold the dental appliance DA and that may be subsequently released.

Notably, while the above examples describe the alteration of the appliance CAD file and/or the providing of the blocking member 400 primarily with respect to the cavity C of the dental appliance DA, it is understood that any area and/or surface of the dental appliance DA may be modified within the CAD file and/or physically blocked by a blocking member 400 to account for the additional layers of materials.

In some embodiments, the final modified item Iₘ includes the combined properties of the initial 3D printed item I plus the properties of the additional material layers. For example, the longitudinal tensile and flexural modulus of a modified item Iₘ with added material layers may be expressed using the equation below:

$${\text{E}}_{\text{coated material}} = {\sum }_{i = 1}^{n} E i v i$$

where:
i = the number of the coating;
E = the elastic modulus of the coated materials in the longitudinal direction;
Ei = the modulus of elasticity of the constituents
vi = the volume fraction (e.g., thickness) of the constituents

In another example, the tensile properties of an item I in the transverse direction with added material layers may be expressed using the equation below:

$$1 / {\text{E}}_{\text{coated material}} = {\sum }_{i = 1}^{n} v i / E i$$

where:
i = the number of the coating;
E = the elastic modulus of the coated materials in the longitudinal direction;
Ei = the modulus of elasticity of the constituents
vi = the volume fraction (e.g., thickness) of the constituents

Similar expressions may be derived for items I with added materials in flexural and shear loading modes, as well as for other pertinent physical and/or mechanical properties.

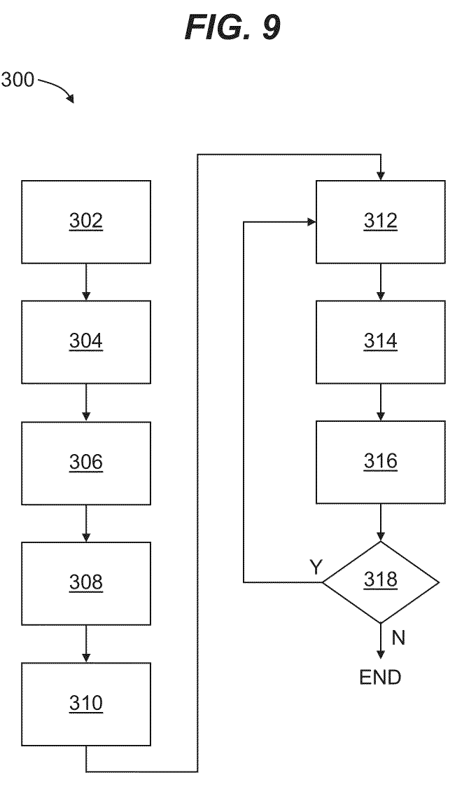

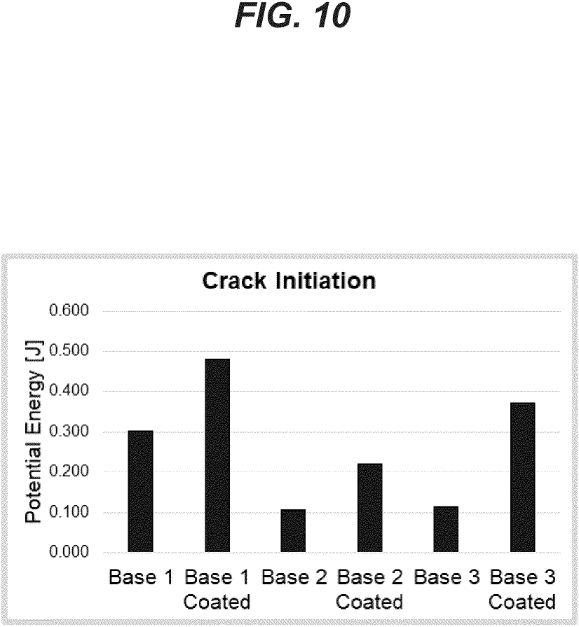

FIG. 9 shows actions 300 that the system 10 may take while producing a dental appliance DA according to exemplary embodiments hereof.

In a first action (at 302), the system 10 receives a 3D CAD file for a desired dental appliance to be fabricated. Next (at 304), the system 10 determines the new layer(s) of material(s) necessary to modify the physical and mechanical properties of the 3D printed appliance as described herein. Knowing this information, the system 10 (at 306) may modify the dimensions and forms of the original CAD file (if deemed necessary) to create an updated 3D CAD file to account for the addition of the new layers of material(s) as described herein.

Next (at 308), the system 10 uses the 3D printing system 100 to print the dental appliance using the original 3D CAD file and/or the updated 3D CAD file as desired. The result is a three-dimensional dental appliance including the form and dimensions of the desired appliance, but not necessarily the physical and/or mechanical properties of the desired appliance.

Next (at 310), the dental appliance from step 308 may be post cured as necessary for the photopolymer resin used to form the appliance to reach its expected specifications and engineering properties (e.g., it’s hardness) and be deemed fully cured. This step may be omitted if the resin used to form the dental appliance in step 308 does not require post curing after the printing process to be fully cured. In either scenario, the 3D printed dental appliance at this stage wherein the photopolymer resin used to print the dental appliance is fully cured may be referred to as a fully cured 3D printed item.

Next (at 312), the system 10 uses an additional additive manufacturing system 200 to apply a layer of material onto one or more surfaces of the dental appliance from step 308 (or 310 if performed). For example, a layer of thermoplastic may be applied to the appliance to add the desirable elastic properties of the thermoplastic to the dental appliance as described herein. The thermoplastic layer may be added using a brushing system 200, a spraying system 200, a dipping system 200, and/or by using other types of additional additive manufacturing systems 200 as required. It is understood that this is just one example and that other types of materials may be added using any types of required systems 200.

Once the first layer has been applied to the dental appliance, the adhesion between the first layer and the dental appliance may be activated (at 314), if necessary, using any appropriate means such as exposure to ultraviolet light, an addition of a curing and/or activation agent, heat, time, etc.

In addition, any additional post curing that may be necessary for the dental appliance and first layer combination may be performed (at 316).

After the first layer of added material has been successfully applied to the dental appliance, the system 10 may determine (at 318) if additional layers are required to be added to the modified dental appliance in any area, e.g., on the same surface, and/or on one or more additional surfaces. If yes, the system 10 returns to 312, and if no, the process may terminate.

It is understood that the actions 300 described above are meant for demonstration and that additional actions also may be taken. In addition, not all actions 300 may be taken and/or the actions 300 may be taken in different order(s).

### Example 1

In one example, the system 10 and method was used to fabricate a plurality of dental appliances according to exemplary embodiments hereof. The system 10 first implemented a 3D printer 100 to fabricate five dental appliances using a first photopolymer resin (UDMA), five dental appliances using a second photopolymer resin (HEMA), and five dental appliances using a third photopolymer resin (bisphenol A). Each of the samples were then tested to determine a baseline impact strength for each.

Next, the system 10 used an additional additive manufacturing system 200 to coat each dental appliance with ~200 µm of a methacrylate-based resin. The coated samples were then cured in a UV oven.

The coated (modified) samples were then retested for impact strength and the results show a significant increase in strength. As shown in FIG. 10, the potential energy required to initiate a crack in the coated samples was much higher than the energy required to initiate a similar crack in the non-coated samples.

### Example 2

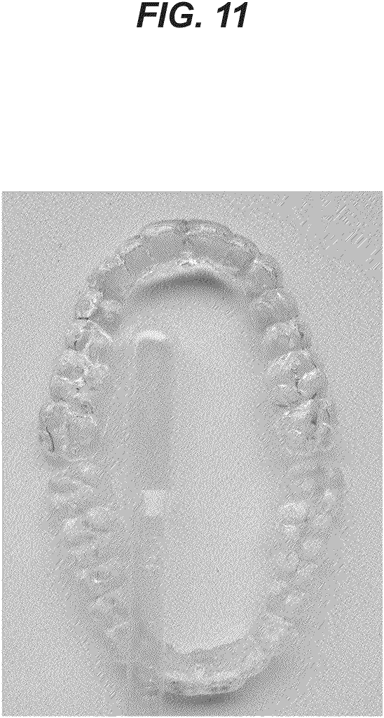

In a second example, the system 10 and method was used to first 3D print a dental appliance using a 3D printer 100, and to subsequently coat each appliance with a layer of pigmented methacrylic UV curable resin using an additional additive manufacturing system 200. As shown in FIG. 11, the coated sample (upper) shows a desirable color and/or transparency change due to the added layer of material compared to the uncoated sample (lower).

It is understood that any aspect or element of any embodiment of the system 10 and method described herein or otherwise may be combined with any other aspect or element of any other embodiment of the system 10 and method to form additional embodiments of the system 10 and method, all of which are within the scope of the system 10 and method.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and / or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of forming a dental appliance comprising:
(A) receiving a design file representing the dental appliance;
(B) printing, using a three-dimensional (3D) printer and the design file, the dental appliance, the dental appliance being fully cured and including at least one initial physical property value;
(C) applying, using a first additive manufacturing system, a first layer of a first material to at least one first surface of the dental appliance to form a modified dental appliance;
wherein the at least one initial physical property value of the dental appliance is changed to a corresponding at least one modified physical property value of the modified dental appliance by the application of the first layer of first material in (C).

2. The method of claim 1 wherein the dental appliance includes at least one of a retainer, and an aligner.

3. The method of claim 1 wherein the at least one initial physical property includes at least one of tensile strength, elasticity, elongation, impact resistance, rigidity, mechanical strength, hardness, wear resistance, color, and transparency.

4. The method of claim 1 wherein the first material includes at least one of thermoplastic, acrylic, and epoxy.

5. The method of claim 1 wherein the first additive manufacturing system includes at least one of a material dipping system, material spraying system, material coating system, material wrapping system, material heat shrinking system, material depositing system, and material painting system.

6. The method of claim 1 further comprising:
(C)(1) curing the first layer of first material on the at least one first surface.

7. The method of claim 1 further comprising:
(C)(1) activating the adhesion between the first layer of first material and the at least one first surface.

8. The method of claim 7 wherein the activating the adhesion between the first layer of first material and the at least one first surface is provided by at least one of exposure to ultraviolet light, an addition of a curing and/or activation agent, exposure to heat, and the passing of time.

9. The method of claim 1 further comprising:
(A)(1) modifying the design file by modifying at least one parameter of the represented dental appliance within the design file.

10. The method of claim 9 wherein the modifying the design file by modifying at least one parameter includes modifying at least one surface of the represented dental appliance within the design file.

11. The method of claim 9 wherein the modifying the design file by modifying at least one parameter includes modifying at least one thickness of the represented dental appliance within the design file.

12. The method of claim 1 further comprising:
(D) applying, using a second additive manufacturing system, a second layer of a second material to at least one second surface of the modified dental appliance to form an additionally modified dental appliance;
wherein the at least one modified physical property value of the modified dental appliance is changed to a corresponding at least one additionally modified physical property value of the additionally modified dental appliance by the application of the second layer of second material in (D).

13. The method of claim 12 wherein the second material includes at least one of thermoplastic, acrylic, and epoxy.

14. The method of claim 12 wherein the second additive manufacturing system includes at least one of a material dipping system, material spraying system, material coating system, material wrapping system, material heat shrinking system, material depositing system, and material painting system.

15. The method of claim 12 wherein the second additive manufacturing system is the same as the first additive manufacturing system.

16. The method of claim 12 further comprising:
(D)(1) curing the second layer of second material on the at least one second surface.

17. The method of claim 12 further comprising:
(D)(1) activating the adhesion between the second layer of second material and the at least one second surface.

18. The method of claim 17 wherein the activating the adhesion between the first layer of first material and the at least one first surface is provided by at least one of exposure to ultraviolet light, an addition of a curing and/or activation agent, exposure to heat, and the passing of time.

19. The method of claim 1 wherein the dental appliance includes a shell with a shell outer surface and a cavity with a cavity inner surface, and the first layer of the first material is applied to the shell outer surface and/or the cavity inner surface.

20. The method of claim 1 further comprising:
(C)(1) obstructing, using a blocking member, at least a portion of dental appliance from the application of the first layer of first material.
